(19) United States
(12) Patent Application Publication
(10) Pub. No.: US 2014/0350857 A1
(43) Pub. Date: Nov. 27, 2014

(54) Method Of Mapping A Subterranean Formation Based Upon Wellbore Position And Seismic Data And Related System

(71) Applicants: Herve Denaclara, Houston, TX (US); Andrew Morgan, Minot, ND (US); Ping Zhang, Albany, CA (US); David L. Alumbaugh, Berkeley, CA (US); Bradley Bryans, Katy, TX (US)

(72) Inventors: Herve Denaclara, Houston, TX (US); Andrew Morgan, Minot, ND (US); Ping Zhang, Albany, CA (US); David L. Alumbaugh, Berkeley, CA (US); Bradley Bryans, Katy, TX (US)

(73) Assignee: SCHLUMBERGER TECHNOLOGY CORPORATION, Sugar Land, TX (US)

(21) Appl. No.: 14/126,396

(22) PCT Filed: Jun. 18, 2012
(86) PCT No.: PCT/US2012/042917

§ 371 Date: Aug. 13, 2014

Related U.S. Application Data
(60) Provisional application No. 61/497,810, filed on Jun. 16, 2011.

(51) Int. Cl. G01V 1/40; G01V 1/00; G01V 3/18

(52) U.S. Cl. CPC G01V 1/40; G01V 3/18; G01V 1/003
USPC 702/6

(57) ABSTRACT

A method of mapping a subterranean formation having at least one wellbore therein may include operating an electromagnetic (EM) signal source and an EM receiver to generate wellbore position data. The method may also include operating a seismic signal source and a seismic receiver to generate seismic data, and generating subterranean formation data based upon the wellbore position data and the seismic data.

### BACKGROUND

Seismic data inversion and reflection imaging are used, for example, in oil and gas reservoir discovery, characterization and monitoring. Seismic data inversion and reflection imaging is the process of transforming seismic data into a quantitative rock-property and structural description of a reservoir. Seismic data inversion and reflection imaging may be pre- or post-stack, deterministic, random, or geostatistical, and may include other reservoir measurements such as well logs and cores, for example.

A seismic survey may be performed to gather, but is not limited to gathering, information about the geology of a hydrocarbon (e.g., oil, natural gas, etc.) and bearing rock formation. The seismic survey records sound waves which have traveled through the layers of rock and fluid in the earth. The amplitude and phase of these sounds waves are used as input to computer processing applications that perform the inversion and imaging tasks.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A method of mapping a subterranean formation having at least one wellbore therein may include operating an electromagnetic (EM) signal source and an EM receiver to generate wellbore position data, and operating a seismic signal source and a seismic receiver to generate seismic data. The method may include generating subterranean formation data based upon the wellbore position data and the seismic data.

A related method of mapping a subterranean formation having at least one wellbore therein may include operating an electromagnetic (EM) signal source and an EM receiver to generate EM data and operating a seismic signal source and a seismic receiver to generate seismic data. The method may further include performing an inversion of the EM data and generating wellbore position data therefrom, and performing an inversion of the seismic data. The method may further include generating subterranean formation data based upon the wellbore position data, and the inverted seismic data.

A related system for mapping a subterranean formation having at least one wellbore therein may include an electromagnetic (EM) signal source and an EM receiver to be associated with the subterranean formation, and a seismic signal source and a seismic receiver to be associated with the subterranean formation. The system may also include a controller to operate the EM signal source and EM receiver to generate wellbore position data and operate the seismic signal source and seismic receiver to generate seismic data. The controller may also be to generate subterranean formation data based upon the wellbore position data and the seismic data.

### BRIEF DESCRIPTION OF THE DRAWINGS

FIG. 1 is a schematic diagram of a system for mapping a subterranean formation in accordance with an embodiment of the present disclosure.

FIG. 2 is a flowchart of a method of mapping a subterranean formation in accordance with an embodiment of the present disclosure.

FIG. 3 is a flowchart of a method of mapping a subterranean formation in accordance with another embodiment of the present disclosure.

FIG. 4 is a schematic diagram of a model of a subterranean formation.

FIG. 5 is a plot of simulated subterranean formation properties based upon an inversion of seismic data for the model of FIG. 4.

FIG. 6 is a plot of simulated subterranean formation properties based upon an inversion of seismic data using wellbore position data from an inversion of EM data for the model of FIG. 4.

FIG. 7 is a plot of simulated subterranean formation properties based upon an inversion of EM data for the model of FIG. 4.

FIG. 8 is a plot of simulated subterranean formation properties based an inversion of EM data using the subterranean formation data for the model of FIG. 4.

### DETAILED DESCRIPTION

The present description is made with reference to the accompanying drawings, in which example embodiments are shown. However, many different embodiments may be used, and thus the description should not be construed as limited to the embodiments set forth herein. Rather, these embodiments are provided so that this disclosure will be thorough and complete. Like numbers refer to like elements throughout, and prime notation is used to indicate similar elements in different embodiments.

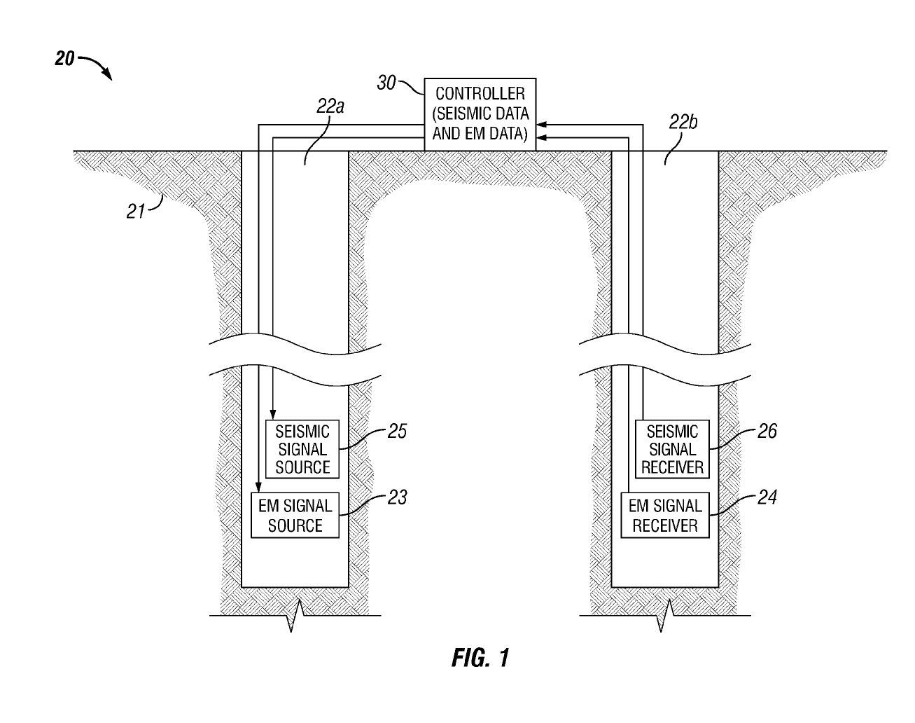

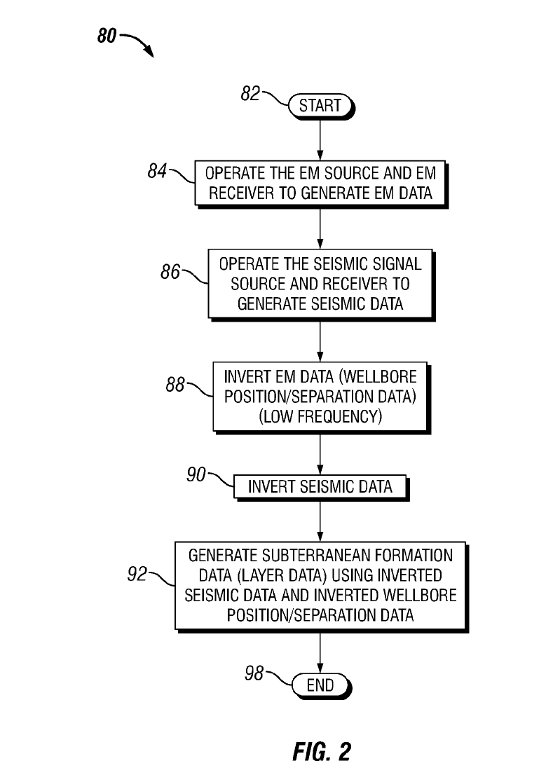

Referring initially to FIG. 1 and beginning at Block 82 of the flowchart 80 in FIG. 2 a method of mapping a subterranean formation 21 and related system 20 are described. The subterranean formation 21 has a pair of spaced apart wellbores 22a, 22b therein. The wellbores 22a, 22b may be spaced apart by a distance of 1,000 meters or more, for example, and may extend downward to 5,000 meters or more within the subterranean formation 21.

An electromagnetic (EM) signal source 23 is within one of the wellbores 22a, and an EM receiver 24 is in the other of the wellbores 22b. A seismic signal source 25 is also within one of the wellbores 22a, and a seismic receiver 26 is within the other of other wellbores 22b. While the EM signal source 23 and the seismic signal source 25 are illustratively in the same wellbore 22a, the EM signal source and the seismic signal source may not be present at the same time or may be in different wellbores. While a crosswell configuration is described herein, it will be appreciated that the subterranean formation 21 may have one wellbore therein and the EM and seismic sources and receivers may be operated in one of a surface to borehole and borehole to surface configuration.

A controller 30 or processor, which may be in the form of a computer, is coupled to the EM source and receiver 23, 24, and the seismic source and receiver 25, 26. The controller 30 may control the activation of the EM and seismic sources 23, 25 and may record the data acquired by the EM and seismic receivers 24, 26. The controller 30 may also perform computational analysis based upon the EM source and receiver 23, 24, and the seismic source and receiver 25, 26.

In a typical processing of seismic data, for example, the seismic data is inverted to obtain a velocity distribution between the two wellbores. The inversion starts from a static velocity model where the distance between the seismic source and seismic receiver is assumed to be known. In the case of surface-to-borehole or crosswell configurations, this would be determined from a deviation survey of the wellbores (gyro) and a correlation with borehole reference logs.

As will be appreciated by those skilled in the art, however, the geographic position or trajectory of each of the wellbores 22a, 22b may vary from the exact planned trajectories within the subterranean formation 21. Therefore the exact locations of the downhole sources and receivers may be uncertain. While a deviation survey may be performed to determine the actual trajectory of the wellbores 22a, 22b, and to determine the actual source and receiver positions, the deviation survey may have limited accuracy. For example, the trajectory of the wellbores 22a, 22b may be determined using a gyro survey. The accuracy of the gyro survey may depend on the equipment used, the methodology, and the depth within the subterranean formation 21 from a surface reference point. The accuracy of the deviation measurement may be 0.1 degrees; and at a 5,000 meter depth, for example, thus may translate to an error in the placement of the wellbores 22a, 22b in the range of 8 meters.

Such an error in the placement or position of the wellbores 22a, 22b, and, accordingly the location of the seismic source 25 and the seismic receiver 26, and as a consequence the distance between the seismic source and seismic receiver may translate to an error in the inverted velocities generated from the seismic measurements. The error in the inverted velocity is based upon, for example, proportional to, the error in the distance between the seismic source 25 and the seismic receiver 26. The table below summarizes this error in a crosswell configuration.

Error in Velocity (%) due to well
position accuracy

| | | Distance between Source & | | | | |
|---|---|---|---|---|---|---|
| | | Receivers (m) | | | | |
| | | 50 | 100 | 250 | 500 | 1000 |
| total | 100 | 1% | 0% | 0% | 0% | 0% |
| depth | 500 | 3% | 2% | 1% | 0% | 0% |
| (m) | 1000 | 7% | 3% | 1% | 1% | 0% |
| | 1500 | 10% | 5% | 2% | 1% | 1% |
| | 2000 | 14% | 7% | 3% | 1% | 1% |
| | 2500 | 17% | 9% | 3% | 2% | 1% |
| | 3000 | 21% | 10% | 4% | 2% | 1% |
| | 5000 | 35% | 17% | 7% | 3% | 2% |

As shown above, the error in velocity may be higher the deeper the wellbore and the closer the seismic source and receiver.

To reduce velocity error due to inaccuracies in the positions of the EM and seismic sources 23, 25, and positions of the EM and seismic receivers 24, 26 in the wellbores 22a, 22b, the geometry correction available from a low frequency EM measurement is applied to refine the source and receiver positions in each wellbore 22a, 22b. In particular, the controller 30 operates the EM signal source 23 and the EM receiver 24 at Block 84 to generate EM data, from which wellbore position and/or separation data can be derived, for example. The wellbore position data is generated based upon a low frequency EM physical property measurement, for example, as will be appreciated by those skilled in the art. The controller 30 operates the seismic signal source 25 and the seismic signal receiver 26, at Block 86, to generate seismic data.

The controller 30 cooperates with the EM source and receiver 23, 24, and the seismic source and receiver 25, 26 to generate subterranean formation data or properties based upon the inversion of the EM data (Block 88) and inversion of the seismic data (Block 90). More particularly, the controller 30 cooperates with the EM source and receiver 23, 24, to perform an inversion of the EM data to generate improved source receiver positions as compared to the assumed or gyro-determined source and receiver positions or separations.

The reduced error position generated from the inversion of the EM data is provided as a basis for building the velocity inversion starting model (seismic source and receiver 25, 26 positions). The seismic data is then inverted based upon the starting model (Block 90). Subterranean formation data is generated based upon the inverted seismic data and the wellbore position/separation data obtained from inverting the EM data (Block 92), and may correspond to layering of the subterranean formation 21, that is, the subterranean formation data in this variation is subterranean formation layer data. In some embodiments, the subterranean formation layer data may be displayed on a display coupled to the controller 30 or rendered in printed form, for example. Additionally, in some embodiments, the subterranean formation data may be further processed, as will be appreciated by those skilled in the art. The method ends at Block 98.

In some embodiments, the controller 30 may perform the inversion of the EM data and the inversion of seismic data jointly. In other words, a single starting model may be used for both the resistivity data and the seismic data. However, a joint inversion may be computationally burdensome or complex.

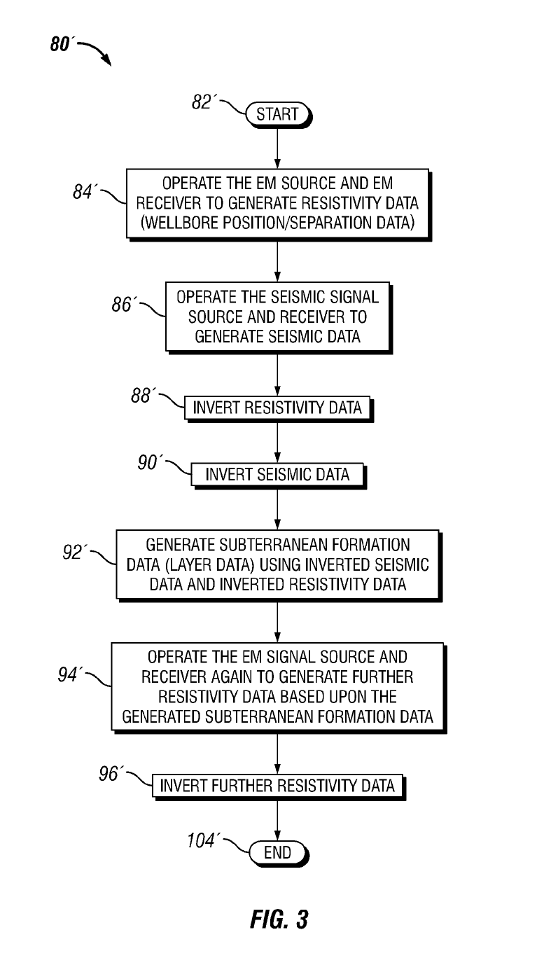

Referring now to the flowchart 80′ in FIG. 3, in another embodiment, the controller 30 generates further subterranean formation data (Block 96′) based upon another inversion of the EM data (Block 94′), and based upon the generated subterranean formation data. More particularly, the generated subterranean formation data is used as a starting point for a relatively high resolution structural model (resistivity model), or high frequency EM inversion model (Block 94′), which generates the further, more accurate, subterranean formation data. The further or second inversion of the EM data is a high frequency inversion of the EM data, while the initial or first inversion of the EM data is a low frequency inversion of the EM data. As will be appreciated by those skilled in the art, the resolution of the seismic measurement can be over 10 times better than the resolution of the EM measurement, and constraining the EM inversion by the inverted seismic data, i.e., subterranean formation data, may improve the EM resolution. Accordingly, more accurate subterranean formation data may be generated, for example, with respect to the wellbore position data initially generated (i.e., at Block 84′). The method ends at Block 98′.

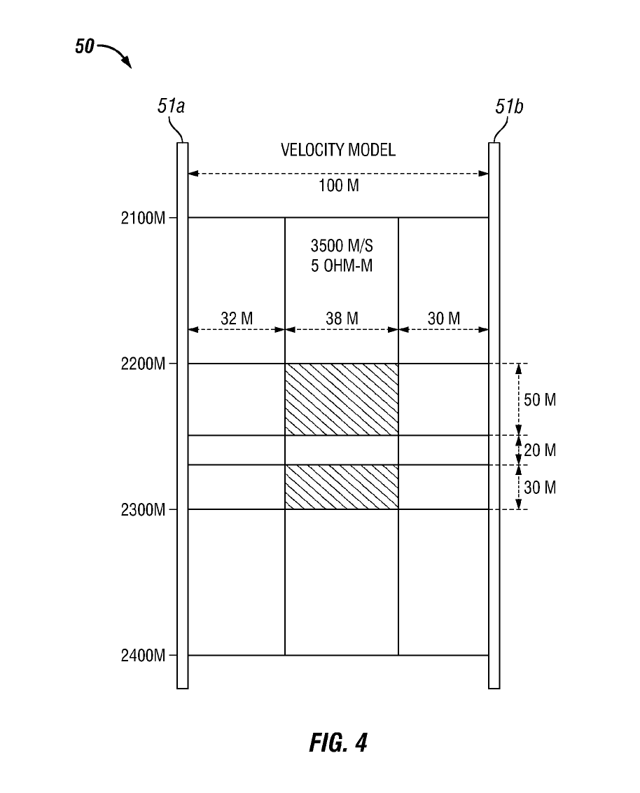

Referring now to the graph 50 in FIG. 4, a simulation is performed according to the present embodiments using a synthetic model representing two zones with higher resistivity and lower velocity as compared to background values described below. A crosswell configuration was simulated to have an actual distance between wellbores 51a, 51b of about 100 meters. The background values include a resistivity of 5 Ohm-m and a velocity of 3500 m/s. The zone of interest had a resistivity of 50 Ohm-m and a velocity 3300 m/s. Error in distance between the two wellbores 51a, 51b was calculated by introducing a 0.1 degree error on the second wellbore 51b.

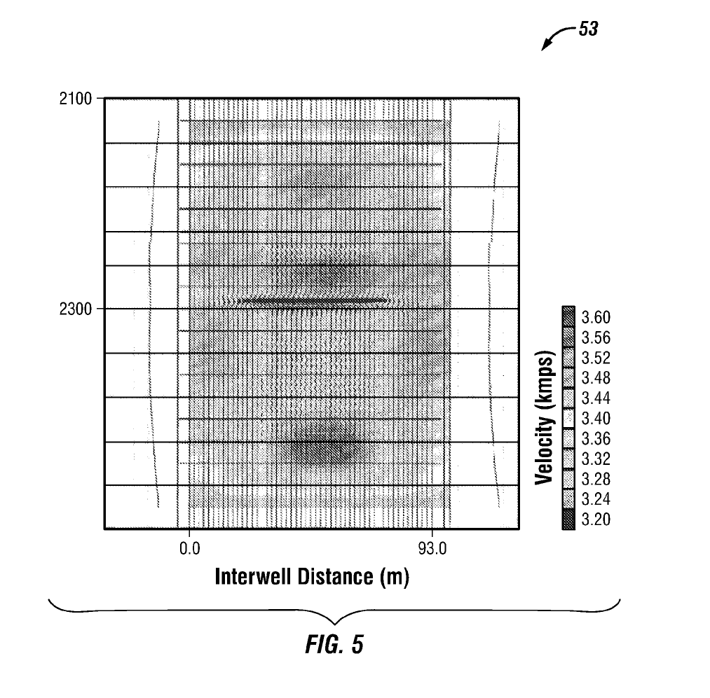

Referring now additionally to the graph 53 in FIG. 5, with respect to seismic inversion, due to the error in the position or trajectory of the second wellbore 51b introduced by the gyro measurement, the seismic inversion/processing results in reflections scattering, reflections depth shift and underestimate of actual velocities. In other words, the graph 53 represents a seismic inversion based upon uncorrected wellbore position data.

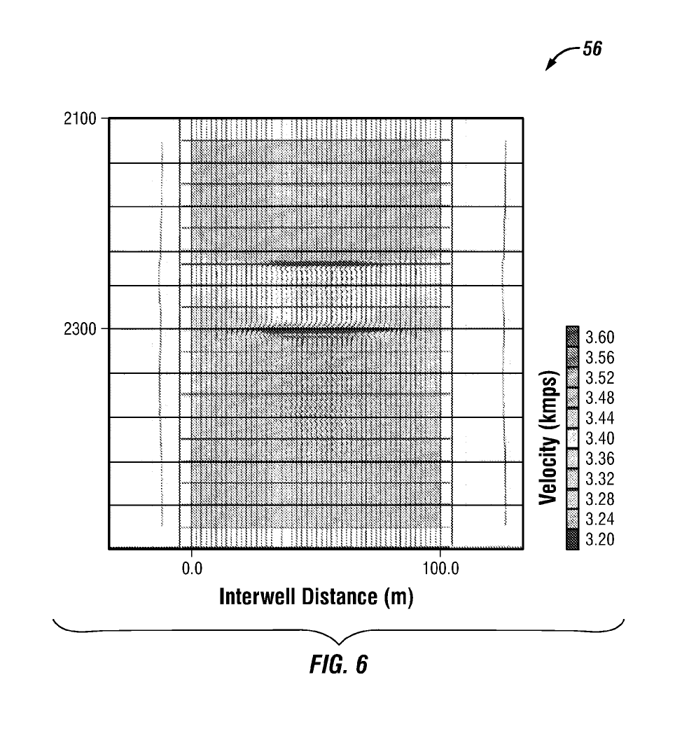

Referring now additionally to the graph 56 in FIG. 6, with respect to a corrected seismic inversion, the distance between the wellbores 51a, 51b is corrected using the low frequency EM geometry correction principle described above and the seismic data is inverted using the corrected wellbore separation. Illustratively, reflections are sharper and more accurate in depth, and velocities are no longer underestimated.

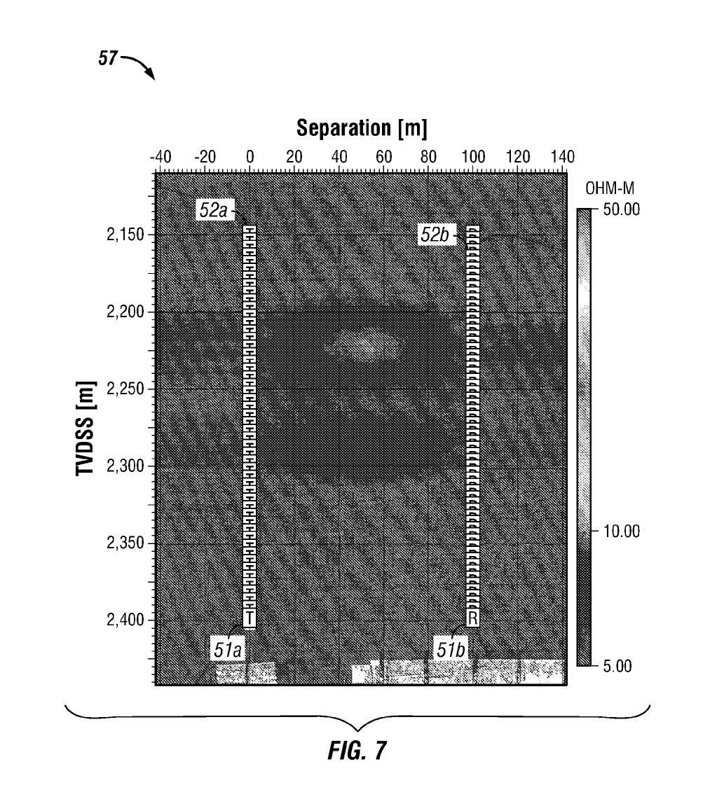

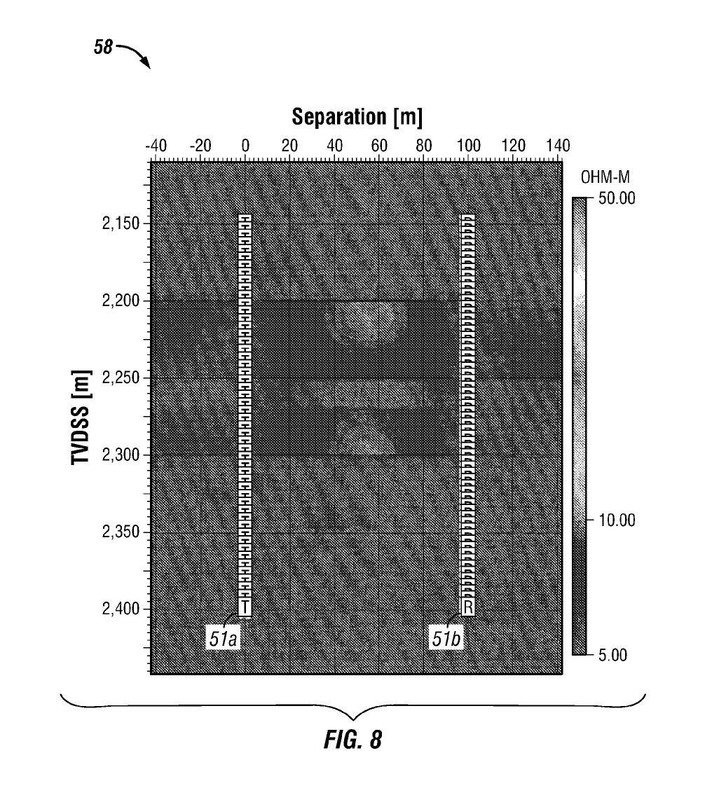

Referring now additionally to the graph 57 in FIG. 7, a typical inverted image for an EM inversion is illustrated. The starting model for the EM inversion is a uniform 5 Ohm-m background model. Referring now additionally to the graph 58 in FIG. 8, the EM inversion is performed by constraining the inversion starting model with the results on the geometry corrected seismic inversion, above in FIG. 6. This leads to improved results in resolution and recovered resistivity values as compared to the graph 57 in FIG. 7.

The present embodiments, advantageously improve the processing of seismic data by correcting or adjusting the inaccuracy of the placement of the seismic source 24 and the seismic receivers 26. Thus, the resolution of the electromagnetic inversion is improved by constraining it with a relatively high resolution geometry corrected model derived from seismic data processing.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

That which is claimed is:

1. A method of mapping a subterranean formation having at least one wellbore therein, the method comprising:
operating an electromagnetic (EM) signal source and an EM receiver to generate wellbore position data; and
operating a seismic signal source and a seismic receiver to generate seismic data; and
generating subterranean formation data based upon the wellbore position data and the seismic data.

2. The method of claim 1, wherein generating the subterranean formation data comprises generating the subterranean formation data based upon inversion of the seismic data.

3. The method of claim 1, wherein operating the EM signal source and EM receiver comprises operating same to generate EM data; and wherein generating the subterranean formation data comprises generating the subterranean formation data based upon inversion of the EM data.

4. The method of claim 3, further comprising generating further subterranean formation data based upon another inversion of the EM data and the generated subterranean formation data.

5. The method of claim 1, wherein generating subterranean formation data comprises generating subterranean formation layer data.

6. The method of claim 1, wherein the at least one wellbore comprises a pair thereof; and wherein the wellbore position data comprises wellbore separation data.

7. The method of claim 1, wherein generating the subterranean formation data comprises generating the subterranean formation data based upon a joint EM and seismic inversion.

8. The method of claim 1, wherein operating the EM and seismic sources comprises operating the EM and seismic sources in one of a crosswell, surface to borehole, and borehole to surface configuration.

9. A method of mapping a subterranean formation having at least one wellbore therein, the method comprising:
operating an electromagnetic (EM) signal source and an EM receiver to generate EM data;
operating a seismic signal source and a seismic receiver to generate seismic data;
performing an inversion of the EM data and generating wellbore position data therefrom;
performing an inversion of the seismic data; and
generating subterranean formation data based upon the wellbore position data, and the inverted seismic data.

10. The method of claim 9, further comprising;
performing another inversion of the EM data; and
generating further subterranean formation data based upon the another inversion of the EM data and the generated subterranean formation data.

11. The method of claim 9, wherein generating subterranean formation data comprises generating subterranean formation layer data.

12. The method of claim 9, wherein the at least one wellbore comprises a pair thereof; and wherein the wellbore position data comprises wellbore separation data.

13. The method of claim 9, wherein generating the subterranean formation data comprises generating the subterranean formation data based upon a joint EM and seismic inversion.

14. The method of claim 9, wherein operating the EM and seismic sources comprises operating the EM and seismic sources in one of a crosswell, surface to borehole, and borehole to surface configuration.

15. A system for mapping a subterranean formation having at least one wellbore therein, the system comprising:
an electromagnetic (EM) signal source and an EM receiver to be associated with the subterranean formation;
a seismic signal source and a seismic receiver to be associated with the subterranean formation; and
a controller to
operate said EM signal source and EM receiver to generate wellbore position data,
operate said seismic signal source and seismic receiver to generate seismic data, and
generate subterranean formation data based upon the wellbore position data and the seismic data.

16. The system of claim 15, wherein said controller is to generate the subterranean formation data based upon inversion of the seismic data.

17. The system of claim 15, wherein said controller is to operate the EM signal source and EM receiver to generate EM data, and generate the subterranean formation data based upon inversion of the EM data.

18. The system of claim 17, wherein said controller is to generate further subterranean formation data based upon another inversion of the EM data and the generated subterranean formation data.

19. The system of claim 15, wherein said controller is to generate the subterranean formation data based upon a joint EM and seismic inversion.

20. The system of claim 15, wherein said controller is to operate the EM and seismic sources in one of a crosswell, surface to borehole, and borehole to surface configuration.
